(19) United States
(12) Patent Application Publication
(10) Pub. No.: US 2008/0250943 A1
(43) Pub. Date: Oct. 16, 2008

(54) Systems and Methods for Dispensing Food

(76) Inventors: Hugues Francois Malandain, Mountain View, CA (US); Andrew Kohm, San Mateo, CA (US); Stuart Smolen, San Mateo, CA (US)

Correspondence Address: Stuart Smolen, 2035 Dublin Way, San Mateo, CA, 94403, US

(21) Appl. No.: 12/058,735

(22) Filed: Mar. 30, 2008

Related U.S. Application Data
(60) Provisional application No. 60/909,418, filed on Mar. 31, 2007.

(51) Int. Cl. A47J 43/04; G07F 11/72; B26B 11/00; G07F 11/16

(52) U.S. Cl. 99/537; 221/30; 221/279; 30/317

(57) ABSTRACT

An apparatus comprises a housing defining a chamber with a first chamber end and a second chamber end, the chamber configured to hold food components. A pressure mechanism is in communication with the chamber and is configured to push the food components toward the second chamber end. The apparatus includes a cutting mechanism coupled to the housing and configured to cut the food components.

This application claims priority to 60/909,418, titled “Systems and Methods for Dispensing Food, filed Mar. 31, 2007, and which is hereby incorporated by reference in its entirety into this application.

### FIELD OF THE INVENTION

The present invention relates generally towards dispensing food. For example, some embodiments relate to systems and methods for dispensing quantities of food from either fresh or previously-prepared food cartridges.

### BACKGROUND OF THE INVENTION

Frozen herbs are often preferred for cooking and other types of food preparation. Reasons include the longer shelf life of frozen herbs as compared to fresh herbs, more consistent and lasting flavor, and more price stability than fresh herbs. Often, dried herbs are substituted for fresh herbs. Dried herbs, unlike frozen herbs, however, cannot be classified as fresh, and often taste and health benefits are lost in the drying process.

Frozen herbs can, at times, have drawbacks, however. For example, they can be messy to work with, and can be difficult to meter and dispense. Thus a need exists for a convenient way to use frozen herbs in a consistent and user-friendly manner.

### SUMMARY OF THE INVENTION

Some embodiments of the present invention relate to methods and apparatuses for dispensing portions of solid food materials. In one embodiment, an apparatus comprises housing defining a chamber with a first chamber end and a second chamber end, the chamber configured to hold food components. A pressure mechanism is in communication with the chamber and is configured to push the food components toward the second chamber end. The apparatus further includes a cutting mechanism coupled to the housing and configured to cut the food components.

### BRIEF DESCRIPTION OF THE DRAWINGS

FIG. 1 is a schematic representation of an embodiment of the invention in which the cutting element translates roughly linearly.

FIG. 2 is a schematic representation of an embodiment of the invention including a press handle.

FIG. 2a is a schematic representation of a cutting element according to an embodiment of the invention.

FIG. 2b is a schematic representation of a cutting element in sealing mode according to an embodiment of the invention.

FIG. 3 is a schematic representation of an embodiment of the invention in which the cutting element rotates relative to the housing.

FIG. 4 is a schematic representation of a cutting geometry on the cutting element according to an embodiment of the invention.

FIG. 5 is a schematic representation of an embodiment of the invention in which the cutting element rotates relative to the housing.

FIG. 6 is a flow chart representing a method of practicing a top-loading embodiment of the invention.

FIG. 7 is a flow chart representing a method of practicing a bottom-loading embodiment of the invention.

FIG. 8 is a schematic representation of a top-loading fresh-herb or stiff cartridge embodiment of the invention.

FIG. 9 is a schematic representation of a bottom-loading fresh-herb or stiff cartridge embodiment of the invention.

FIG. 10, including FIGS. 10a and 10b, is a schematic representation of a combination of door or gate and cutting element according to an embodiment of the invention.

FIG. 11 is a schematic representation of an embodiment of the invention including an element that allows the cavity to be exposed.

FIG. 12 is a schematic representation of a non-manual embodiment of the invention.

FIGS. 13, 13a and 13b are a schematic representations of an embodiment of the invention with a substantially-radial dispenser.

FIG. 14 is a schematic representation of an embodiment of the invention in which predetermined shapes of stiff food is dispensed.

FIG. 15 is a schematic representation of an embodiment of the invention including a unitary-piece handle.

FIG. 16 is a schematic representation of an embodiment of the invention including a dual-sided actuation of the cutting element.

FIG. 17, including FIGS. 17a-17d, are schematic representations of an embodiment of the invention including a food processor with multiple chambers for the same or different kinds of food showing a variety of shapes for a cutting element.

FIG. 18, including FIG. 18a-18d, are schematic representations of an embodiment of the invention including an actuator that converts lateral motion to rotary motion.

FIG. 19a through FIG. 19e are schematic representations of embodiments of the invention including various means for covering an opening in a cavity.

FIG. 19 is a schematic representation of a mold to create cartridges, according to an embodiment of the invention.

FIGS. 20a and 20b are schematic representations of a mold to create cartridges by packing the food, according to an embodiment of the invention.

FIGS. 21 and 21b are schematic representations of a mold that may or may not have a rigid support, according to an embodiment of the invention.

FIG. 22 is a schematic representation of a mold from which cartridges can be popped out, according to an embodiment of the invention.

FIG. 22 is a schematic representation of a tube mold according to an embodiment of the invention.

FIG. 23 is a schematic representation of a twist mold according to an embodiment of the invention.

FIG. 24 is a schematic representation of a disposable mold according to an embodiment of the invention.

FIG. 20a and FIG. 20b are schematic representations of embodiments of the invention including an actuator that converts rotary motion to lateral motion.

FIG. 21 is a schematic representation of an embodiment of the invention including an element that adjusts the quantity of food being cut.

### DETAILED DESCRIPTION

Before the subject devices, systems and methods are described, it is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

Unless defined otherwise, all technical and scientific terms used herein have the same meaning as commonly understood by one of ordinary skill in the art to which this invention belongs.

It must be noted that as used herein and in the appended claims, the singular forms “a”, “an”, and “the” include plural referents unless the context clearly dictates otherwise. All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided might be different from the actual publication dates, which may need to be independently confirmed.

The present invention will now be described in greater detail by way of the following description of exemplary embodiments and variations of the devices and methods of the present invention. The invention generally includes a housing configured to hold a cartridge of substantially solid food. For the purposes of the present invention, the term “sold food” can include food in its natural form, food that has been dried, freeze dried, frozen, compressed, or any other food capable of being cut. For the purposes of the present invention, the word “cut,” and it's grammatical variants such as “cutting,” are intended to include includes “sliced,” “grated,” “torn,” “broken,” “shredded,” “sheared,” “separated,” (and their appropriate grammatical variants) or any other means that will transform a block or piece of a given size of food into smaller blocks or pieces.

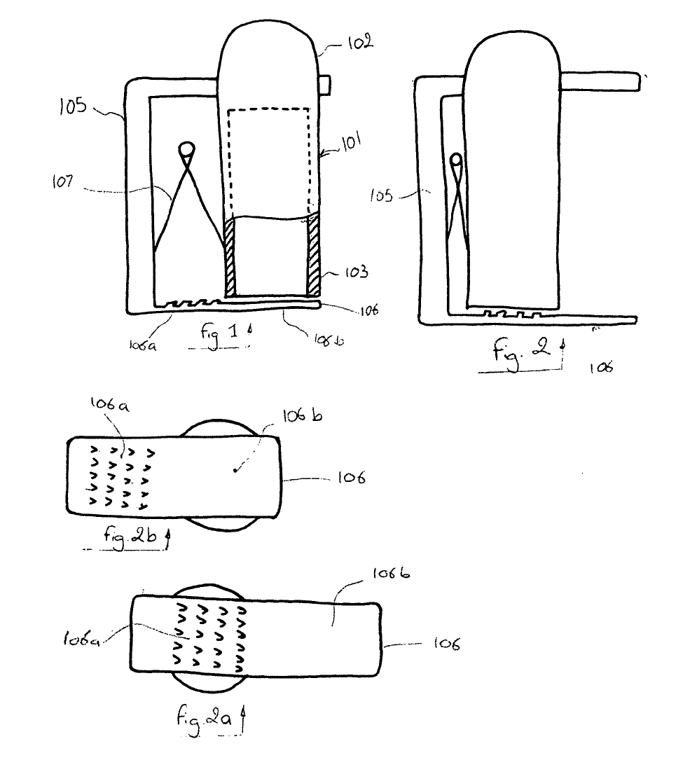

FIG. 1 is a schematic representation of a food processor, according to an embodiment of the present invention. The food processor includes a housing 101 with a first end 102 and a second end 103. The housing defines a cavity 104 configured to contain solid food. In some embodiments, the cavity can be loaded at or near first end 101, second end 103, or somewhere in between first end 101 and second end 103. Cavity 104 includes an opening at or near second end 103 to facilitate in dispensing the solid food.

Coupled to housing 101 is cutter 106. Cutter 106 is coupled to housing 101 in a way that is slidable, rotatable, or any way that allows cutter 106, when actuated, to move relative to cavity 104 to cut food. Cutter 106 can be actuated directly by hand, or by means of a handle, or by means of a motor, or in any way that is practicable. For the purposes of the present invention, the term “cutter” includes a slicer, a grater, or any means for removing a portion of solid food from inside cavity 104.

In one embodiment of the invention, cutter 106 is coupled to handle 105. Cutter 106 can be coupled to handle 105 directly, through a unitary construction, or through a hinge, or via a member, or in any practicable way that allows a user to actuate the cutter by using the handle.

Handle 105 can be coupled to housing 101 in way that is slidable, rotatable, or any way that allows cutter 106 to move relative to cavity 104 to cut food. For the purposes of the present invention, the term “cutter” includes a slicer, a grater, or any means for removing a portion of solid food from inside cavity 104. Handle 105 can be coupled to housing 101 at or near first end 102, at or near first end 103, anywhere in between first end 101 and 102, or any combination thereof that facilitates cutting the solid food. Handle 105 is configured to be squeezed, rotated, pulled, or pushed to move cutter 106 relative to the housing. Thus, handle 105 can be coupled to a device, such as spring 108, that provides a bias away from housing 101, or in any direction that allows the handle to be actuated, thereby moving cutter 106 relative to housing 101.

Cutter 106 includes cutting portion 106a, and door portion 106b. Cutter 106 is configured to sit in a first position in which door portion 106b blocks food from leaving housing 101. When handle 105 is actuated, for example, by hand, cutter 106 is configured to move relative to housing 101 such that door portion 106b moves out of the way and allows cutting portion 106a to move in a way that cuts food located in cavity 104 in housing 101.

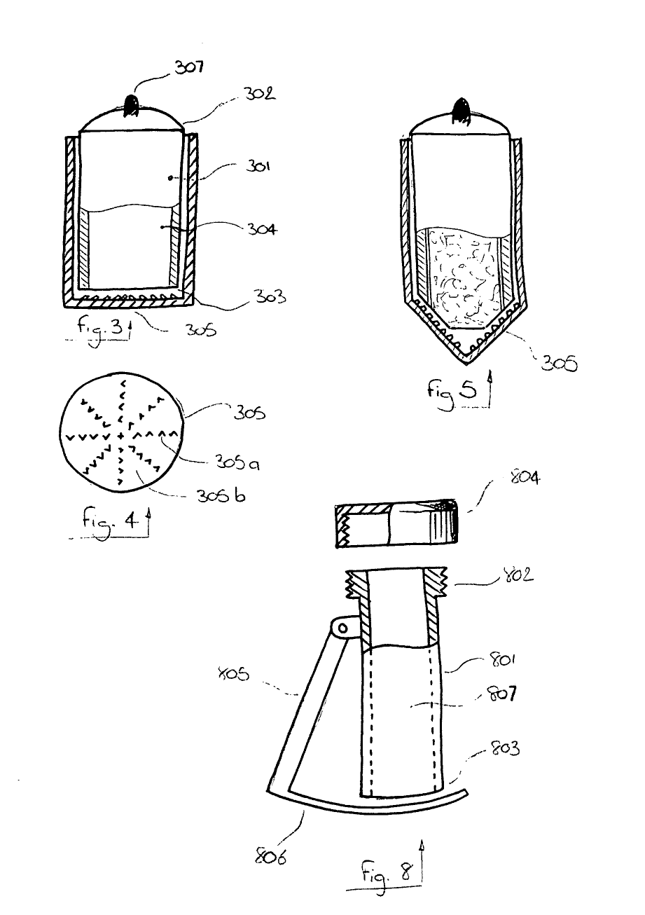

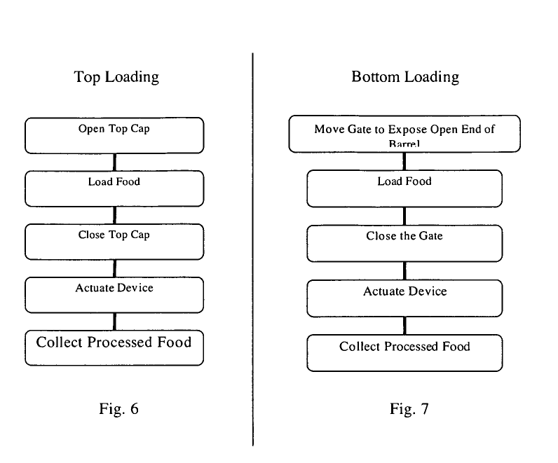

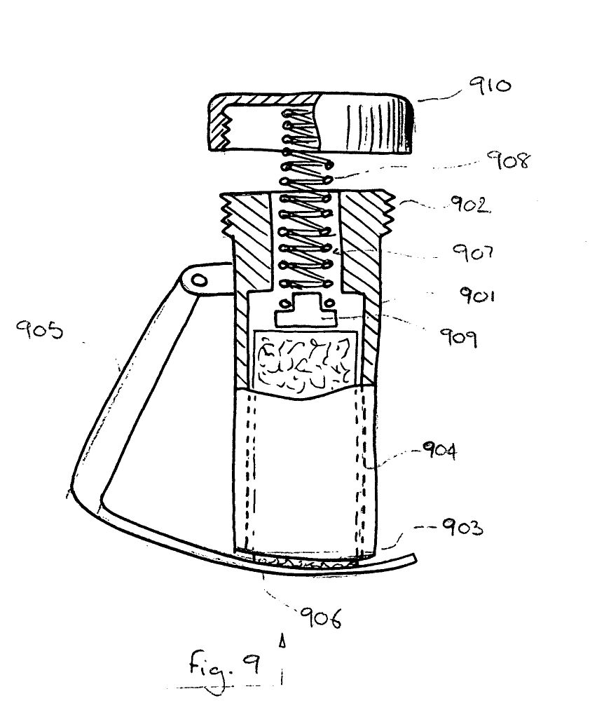

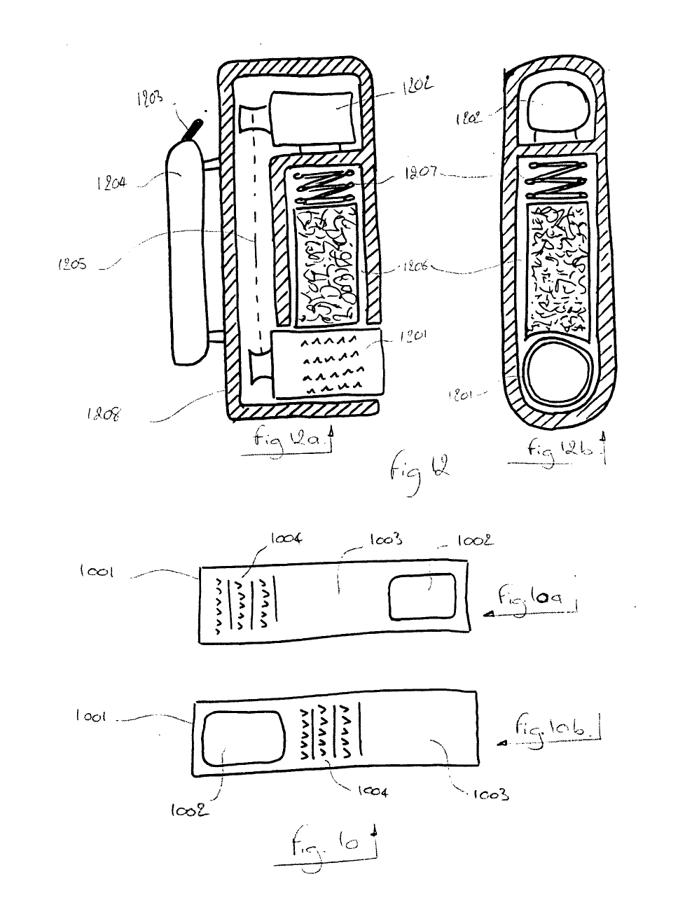

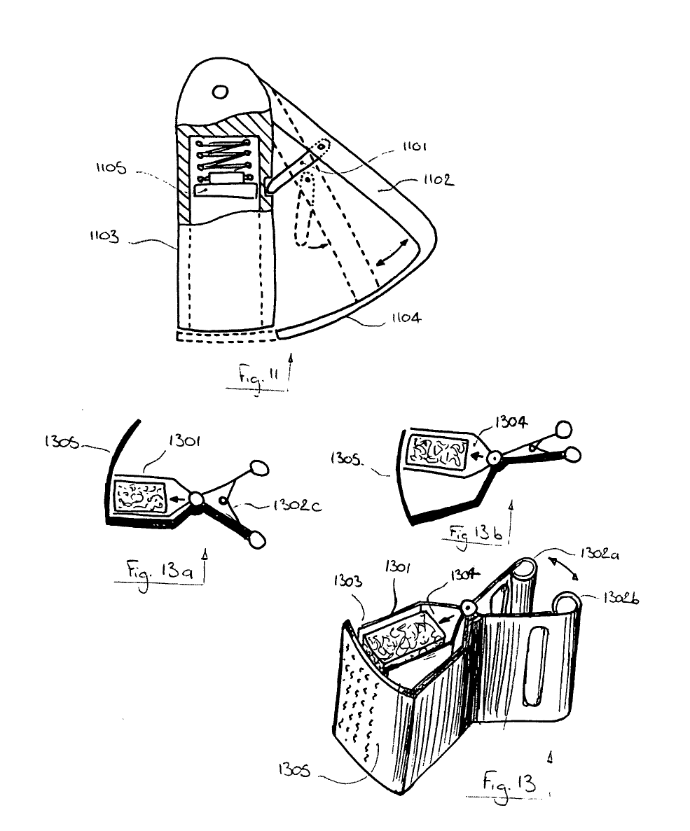

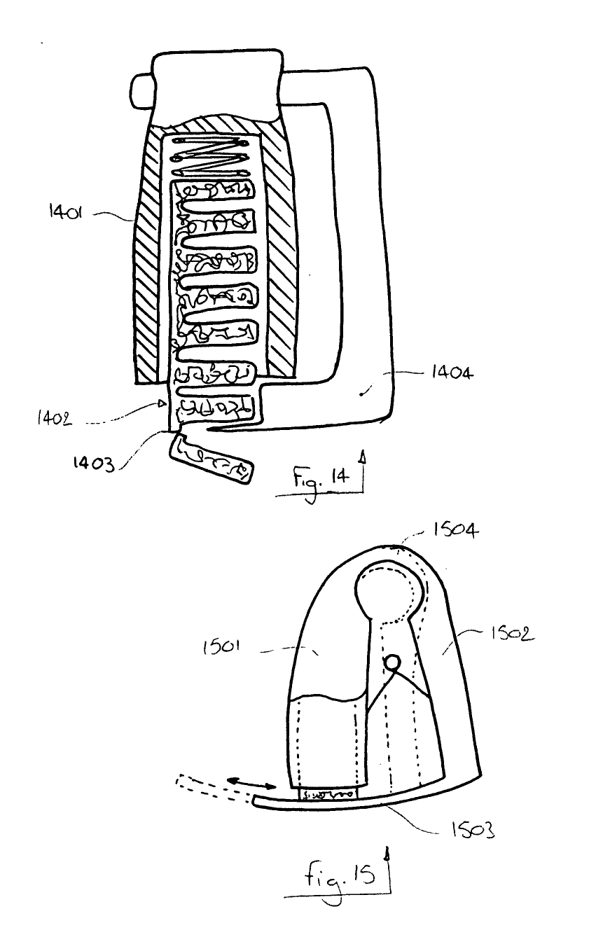

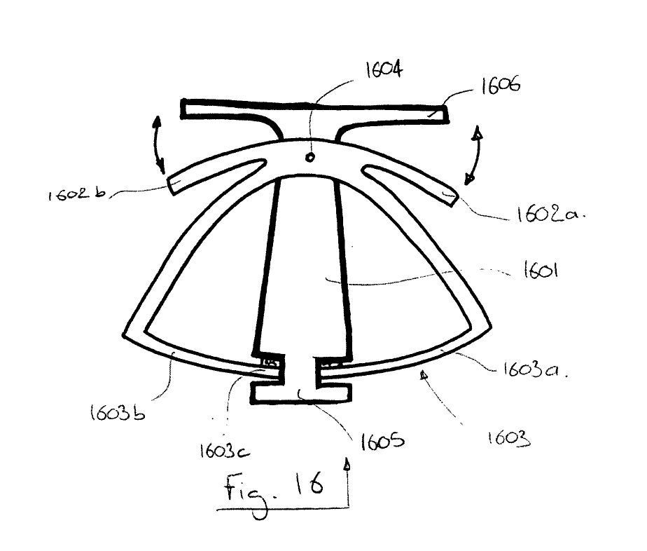

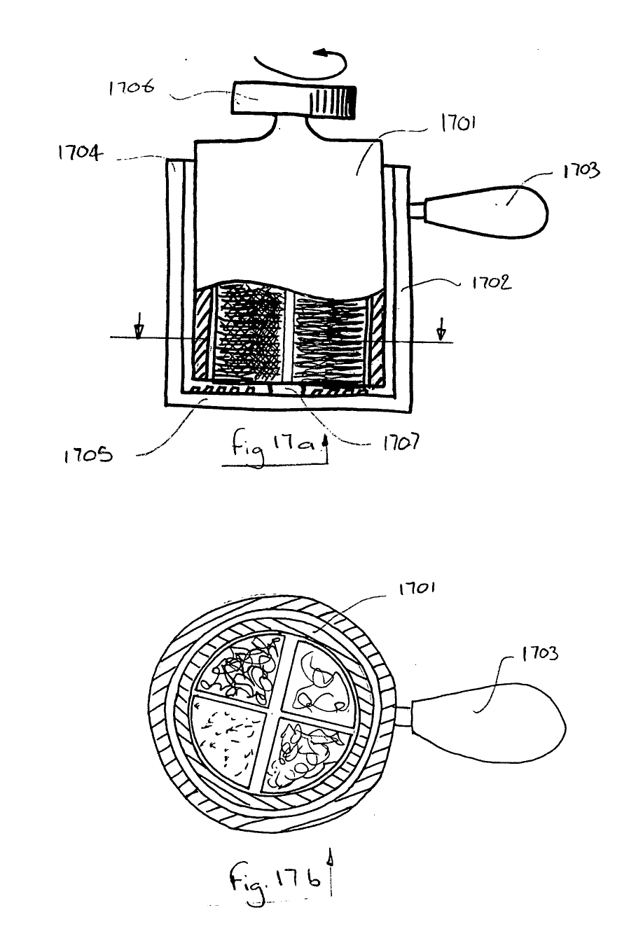

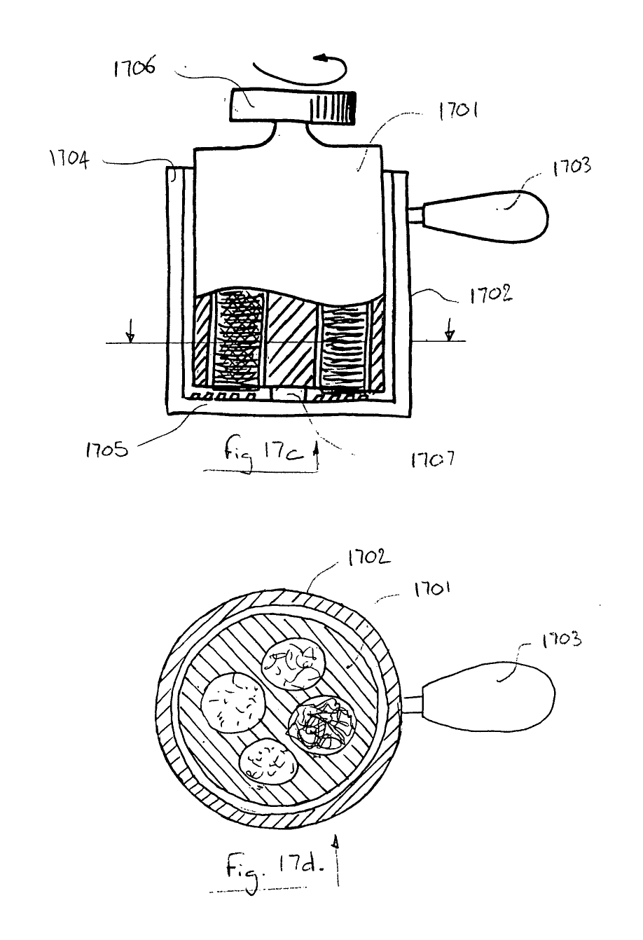

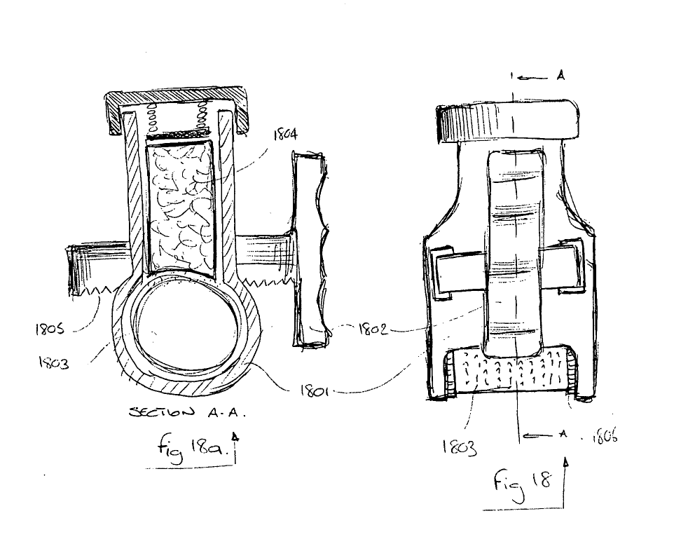

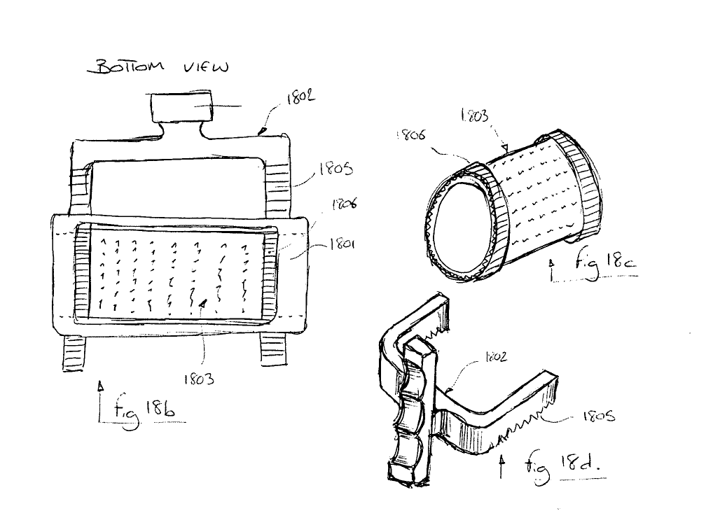

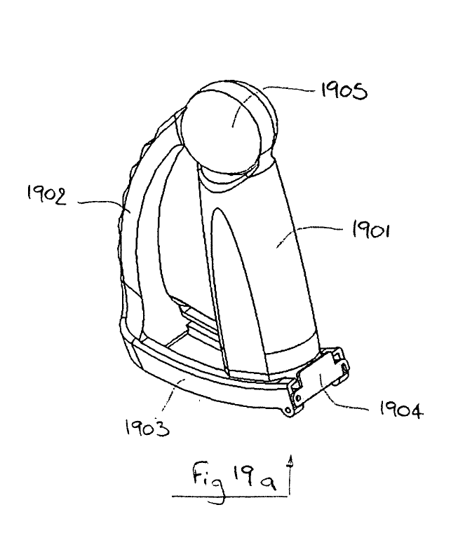

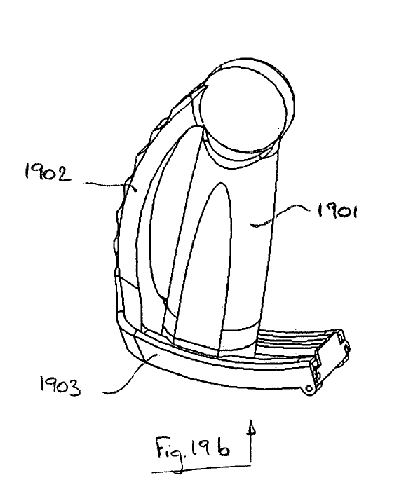

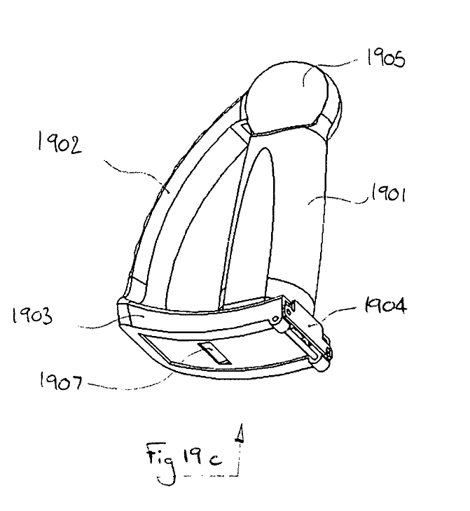

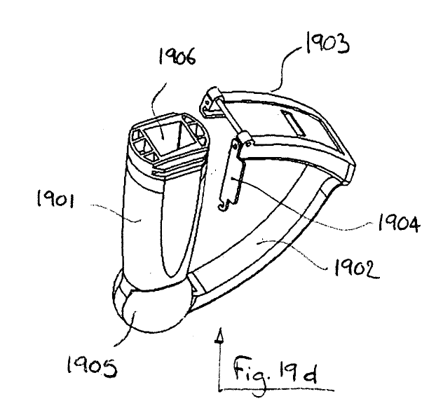

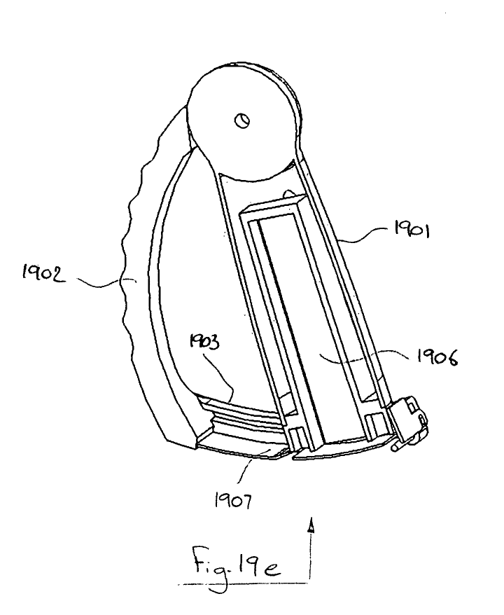

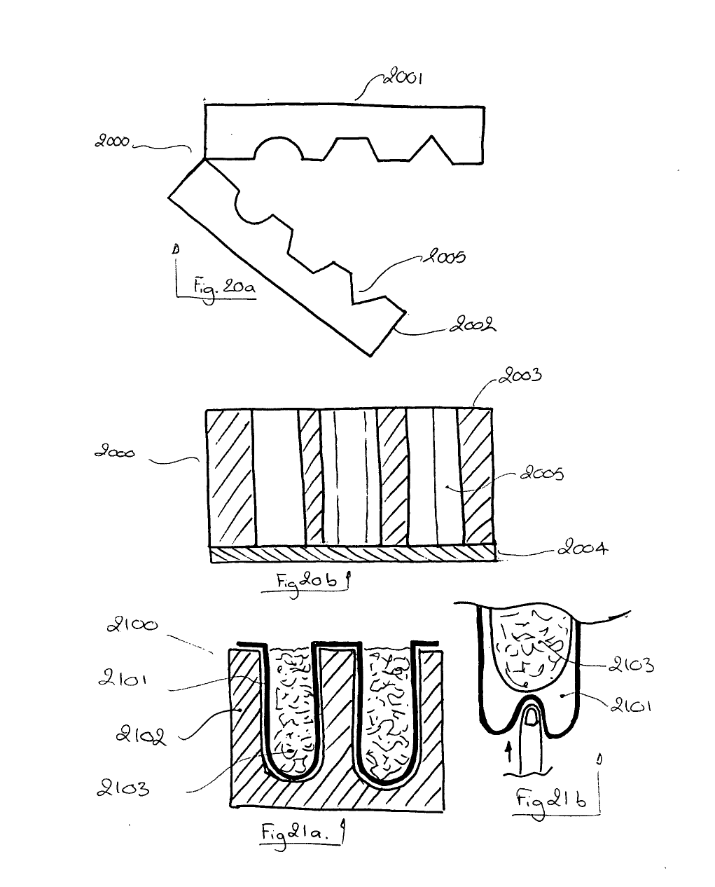

FIG. 2 is a schematic representation of a food processor according to an embodiment of the invention. In this representation, handle 105 is actuated to move cutter 106. FIGS. 2a and 2b are axial schematic representations of cutter 106 relative to cavity 104. In FIG. 2b, cutter 106 is located in a first position such that door portion 106b blocks food from exiting cavity 104. In FIG. 2a, cutter 106 has moved relative to cavity 104 in a way that allows solid food located in cavity 104 to be cut by cutting portion 106a.

FIG. 3 is a schematic representation of a food processor according to an embodiment of the present invention. In this representation, housing 301 includes a first end 302, and second end 303, and a cavity 304 configured to contain solid food.

Housing 301 can be rotatably coupled to cutter 305. Cutter 305 is configured to cut food at or near second end 303 perpendicular to an axis of rotation, or at an angle to the axis of rotation (see FIG. 5), and can be coupled to handle 306, again, either through unitary construction or nonunitary construction.

Handle 306 is configured to be rotated or translated, and is coupled to cutter 305 in a way that allows cutter 305 to move (e.g., rotate or translate) relative to housing 301 in a way that facilitates cutting solid food at or near second end 303, with a portion of solid food being contained within cavity 304.

In one embodiment, handle 306 is coupled to housing 301 at or near second end 303 through cutter 305. In another embodiment, handle 306 is rotatably coupled to housing 301 at or near first end 302. Optionally, the food processor can include a holding element 307 either fixedly coupled to housing 301, or coupled to handle 306 in a way that allows for relative movement between housing 301 and cutter 305.

FIG. 4 is a schematic axial view of cutter 305, including cutting portion 305a and door portion 305b.

FIG. 5 is a schematic representation of a cutter, according to an embodiment of the present invention. In this embodiment, cutter 305 is at a non-normal angle relative to its axis of rotation.

FIG. 6 is a flow chart of a method of practicing a top-loading embodiment of the invention. In this embodiment, the top cap is opened at 601. At 602, the food is loaded, and at 603 the top cap is closed. At 604, the device is actuated to cut the food. In one embodiment, the method is performed manually. In another embodiment, the method is automated, and possibly controlled by software running the flowchart, or some subset of the flowchart.

FIG. 7 is a flow chart of a method of practicing a bottom-loading embodiment of the invention. At 701, the open end of the barrel is opened proximal the cutting portion. At 702, the food is loaded into the barrel through this opening. The gate is then closed at 703. At 704, the device is actuated. In one embodiment, the method is performed manually. In another embodiment, the method is automated, and possibly controlled by software running the flowchart, or some subset of the flowchart.

FIG. 8 is a schematic representation of an embodiment of the invention that includes housing 801 with first end 802 and second end 803. In this embodiment, housing 801 includes an opening at or near first end 802 that is configured to receive solid food. The opening can be left open, or can be closed by cap 804, or any other means of closing, including but not limited to an internal plug, a trap door, or any other means for closing the top that is consistent with the invention.

As in the other embodiments, housing 801 can be coupled to handle 805 in a way that allows cutter 806 to move relative to cavity 807 to facilitate cutting the solid food at or near second end 803.

FIG. 9 is a schematic representation of an embodiment of the invention that includes housing 901 with first end 902 and second end 903. In this embodiment housing 901 includes an opening at or near second end portion 903. The opening at or near second end portion 903 in housing 901 is configured to accept solid food into cavity 904. In one configuration, cutter 906 can move completely away from the opening. Alternatively, cutter 906 can include a window along with a cutting portion and a door portion (not shown).

Cutter 906 can be configured to move rotationally, translationally, in an arcuate manner, or in any way that facilitates cutting, closing, loading, or any of the functions described herein. As shown in FIG. 9, cutter 906 is coupled to handle 905. Handle 905 can include a member that engages housing 901 to hold open the cavity to facility loading solid food into the cavity.

In certain embodiments of the invention, housing 901 can include a way of imposing a downward force on the solid food contained in housing 904. This downward force can be imposed by, for example, spring and plunger assembly 907, or by any other practicable means, such as an air- or oil-loaded piston. Spring and plunger assembly 907 can include spring 908 and pushing member 909. Assembly 907 can be coupled to housing 901 at or near, for example, first end portion 902. The downward force can be fixed, or can be altered by any appropriate means. For example, the downward force can be altered by including screw or screw-type cap 910 that allows a user to change the height of spring assembly 907 within cavity 904. In one embodiment, the food can be loaded without much force. The gate can then be closed and downward force can be applied. Alternatively, the force can be applied by closing the cap.

In any embodiment of the invention, the cutter can be actuated by hand by way of direct contact with the cutter, or by way of an actuation handle. Alternatively, the cutter can be actuated without a handle by way of a coupling with a motor.

FIG. 10a and FIG. 10b portray a door/cutter/gate combination for cutting element 1001 according to an embodiment of the invention. In FIG. 10a, cutting element 1001 comprises door 1002, gate 1003 and blade assembly 1004, all of which can be placed in a variety of configurations on cutting element 1001. In the embodiment shown in FIG. 10a, door 1002 is followed by gate 1003, which is followed by cutter 1004. In FIG. 10b, the door 1002 is followed by the cutter 1004, which is followed by the gate 1003. In its resting position (i.e., before actuation), cutting element 1004 is positioned in such way that door 1002 covers an opening in the housing (not shown), thereby blocking access to food inside the cavity (not shown). In one embodiment, cutting element 1001 comprises at least one detent (not shown). To expose the cavity and/or cut the food through actuation of cutting element 1001, sufficient pressure must be applied to the actuator (e.g., the handle) to overcome the detent. The operator can expose the food through the door 1002 by overcoming the stop.

FIG. 11 is an embodiment of the invention that includes a member 1101 that can apply a force pushing handle 1102 away from housing 1103. As handle 1102 moves relative to housing 1103, cutting portion 1104 moves across the opening and cuts the food being pushed toward the opening by pushing element 1105. In one embodiment, member 1101 is configured to hold handle 1102 away from housing 1103 so that the opening is free to receive food. Member 1101 can serve the dual role of a pushing element and a locking element. In one embodiment, member 1101 can be moved from a first, pushing position, to a second, locking position.

FIG. 12a and FIG. 12b are schematic representations of embodiments of the invention in which the cutting portion is actuated non-manually. FIG. 12b is a longitudinal cross section of FIG. 12a. In this embodiment, cutting portion 1201 can be actuated with motor 1202, electrically, hydraulically, pneumatically, or in any other practicable way. For example, in one embodiment, switch 1203 located by or near a handle 1204 and is used to actuate the driving mechanism 1205, for example a belt, chain, or any other way practicable, linking motor 1202 with cutting portion 1201. In another embodiment (not shown) motor 1202 could be directly coupled with cutting portion 1201. In this embodiment, the food can be located in a chamber 1206 and pressed against the cutting portion 1201 by pressing element 1207, for example a spring. The entire system can be contained within housing 1208. In another embodiment, various parts of the device (e.g., chamber 1206) can be exposed to ease loading or cleaning.

FIG. 13 is a schematic of an embodiment of the invention that includes a scissor-type actuator for moving cutter 1305. In this embodiment, housing 1301 is coupled to member 1302a, either fixedly or rotatably, and is also either fixedly or rotatably coupled to member 1302b. Member 1302b is also coupled to cutter 1305. Members 1302a and 1302b are fixedly or rotatably coupled to housing 1301 in any combination that allows actuation of members 1302a and 1302b to move cuter 1305 relative to cavity 1304. Spring 1302c is coupled to members 1302a and 1302b to apply a separating force between the two members.

In many embodiments of the invention, the cutter can be removable, replaceable, or otherwise exchanged for other types (including other shapes and sizes) of cutters.

FIG. 14 is a schematic representation of an embodiment of the invention in which predetermined shapes of stiff food is dispensed. In this embodiment, housing 1401 is configured to receive and contain a cartridge of solid or frozen food 1402, the cartridge having predetermined breaking points at 1403. The housing can be configured to be loaded from the top end or the bottom end. In this embodiment, element 1404 can cut or shave parts of the frozen cartridge, either at the predetermined breaking points 1403, or elsewhere on frozen food cartridge 1402. Alternatively, element 1404 can break off pieces of predetermined size from cartridge 1402 by applying pressure to the cartridge 1402.

FIG. 15 is a schematic representation of an embodiment of the invention including a unitary-piece handle. In this embodiment, housing 1501 and handle 1502 are constructed as a unitary piece through, for example, injection molding. Cutting element 1503 can also be part of this unitary construction, or can be removable. In one embodiment, cutting element 1503 is attached to housing 1501 by handle 1502. Handle 1502, in turn, is coupled to housing by 1501 through living hinge 1504.

FIG. 16 is a schematic representation of an embodiment of the invention including a dual-sided actuation of the cutting element. In this embodiment, cutting element 1603 has at least two cutting portions 1603a and 1603b, which are separated by door portion 1603c. The cutting portion or portions can be actuated by depressing alternatively handle 1602a and 1602b towards top handle 1606, causing it to rotate, pivot, pendulum, or “see-saw” around pivot point 1604 on housing 1601. Leg 1605 can be coupled to housing 1601 to allow the device to stand by itself. In another embodiment, the cutting element has only one cutting portion 1603c, and two door portions 1603a and 1603b. In another embodiment, the cutting element consists of single-sided actuation. In such an embodiment, an element (not shown), for example a spring, can be used in order to bias away handle 1602 from 1606.

FIG. 17a through FIG. 17d are schematic representations of an embodiment of the invention including a food processor with one (FIG. 17a) or multiple (FIG. 17c) chambers for the same or different kinds of food, with the same or different shapes for the cutting element 1705. FIG. 17b and FIG. 17d are cross sections of FIG. 17a and FIG. 17c, respectively, showing multiple chambers for holding food. External housing 1702 is coupled to handle 1703. External housing 1702 comprises first end 1704 and second end 1705. Internal housing 1701 is inserted into external housing 1702 at or near first end 1704 and rests on or near second end 1705. In this embodiment, handle 1706 can be rotated around axis 1707 causing the cutting elements placed at or near second end 1705 to cut food. In another embodiment, internal housing 1701 and be moved in any direction relative to external housing 1702 in order to cut food.

FIG. 18 is a schematic representation of an embodiment of the invention including actuating handle 1802 that converts lateral motion to rotary motion. In this embodiment, housing 1801 contains rotary cutting element 1803, food 1804, and guides actuating handle 1802 in translation. In this embodiment, the lateral or translational motion of handle 1802 into the rotary motion of cutting element 1803 is achieved by a system of rack 1805 and pinion 1806.

FIG. 18a is a cross section view of FIG. 18.

FIG. 18b is a bottom view according to an embodiment.

FIG. 18c. is a perspective view of the cutting element 1803.

FIG. 18d is an exploded view of the actuating handle 1802.

FIG. 19a is a schematic representation of an embodiment of the invention including housing 1901, actuating handle 1902, and cutting element 1903. Housing 1801 can be coupled to actuating handle 1902 by means of a living hinge 1905, or alternatively by a ball joint or other type of movable hinge. In one embodiment, cutting element 1903 includes stop 1904 to help position cutting element 1903 relative to housing prior to actuation. FIG. 19b is a schematic representation of an embodiment of the invention in which actuating handle 1902 is depressed, causing cutting element 1903 to move relative to housing 1901, thereby exposing and cutting any food inside cavity 1906.

FIG. 19c is a schematic representation of an embodiment of the invention in which cutting element 1903 contains blade 1907 to slice food contained within cavity 1906. Cutting element 1903 is solid on one or both sides of blade 1907 to contain the food within cavity 1906. In one embodiment, blade 1907 can be a grater, and the blade or grater can be exchanged for another blade or grater.

FIG. 19d is a schematic representation of an embodiment of the invention in which stop 1904 can be coupled to cutting element 1903 by a hinge, and can be moved out of the way, allowing a user to access one or more cavities 1906 inside housing 1901 so frozen food cartridges, for example, can be inserted, or the chambers can be emptied and/or cleaned.

FIG. 19e is a cutaway view of an embodiment of the invention, showing housing 1901, actuating handle 1902, cutting element 1903, cavity 1906 and blade 1907.

### Frozen Food Cartridges

FIG. 20a and FIG. 20b are schematic representations of molds for forming frozen food cartridges, according to an embodiment of the invention. In FIG. 20a, mold 2000 comprises a top portion 2001 with a first end and a second end, and a bottom portion 2002 with a first end and a second end. Top portion 2001 can be coupled to bottom portion 902 at first the first end by an active hinge, a living hinge, or in any way that facilitates loading and removing food from mold 2000. In another embodiment of the invention, Top portion 2001 can be independent of bottom portion 2002, and fit together by means of a tab and slot arrangement, or any way in which top portion 2001 and bottom portion 2002 contact each other.

FIG. 20b is a top-down view of a cross section of mold 2000 according to an embodiment of the invention. In this embodiment, mold 2000 includes end 2003 and 2004 both of which are closed walls when top portion 2001 and bottom portion 2002 are in contact with each other. In another embodiment, end 2003 can be open to facilitate placing food inside mold 2000, while end 2004 can be a closed wall to contain the food. In this embodiment, food can be placed in the mold into chambers 2005, and can be packed or compressed with a plunger (not shown), or by means of a cap (not shown) placed over end 2003.

FIG. 21a is a schematic of a cross section of a mold according to an embodiment of the invention. In this embodiment, mold 2100 includes chambers 2101, and is bounded by either a hard support or a soft support on portion 2102. As shown in FIG. 21b, mold 2100 can be configured in a way that allows food 2103 in chamber 2101 to be “popped out” of the chamber when the food is ready for use.

FIG. 22 is a schematic representation of a tube mold according to an embodiment of the invention. In this figure, mold 2200 comprises side walls 2201, top portion 2202 and bottom portion 2203. Side walls 2201 form a cavity (not shown) inside that is bounded on top portion 2202 by a solid end, and on bottom portion 2203 by a removable cap 2204 to facilitate loading and removing food from the cavity.

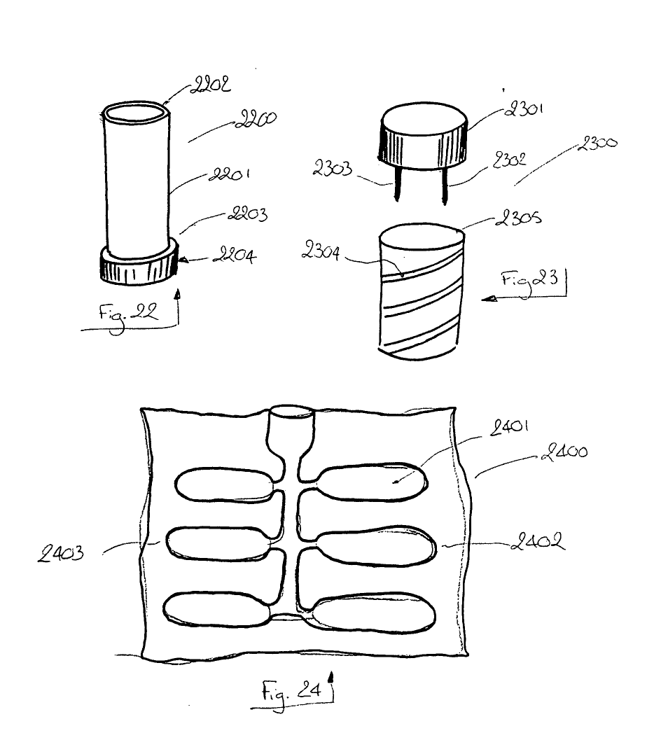

FIG. 23 is a schematic representation of a mold according to an embodiment of the invention. In this embodiment, mold 2300 is configured to receive cap 2301. Cap 2301 can include members 2302 and 2303 that are configured to be in communication with food contained in mold 2300. In this embodiment, food such as herbs, spices, or any combination thereof can be loaded into mold 2300 in a mixture that allows, for example, for freezing the food. When cap 2301 is removed from mold 2300, members 2302 and 2303 are configured to pull the food out from mold 2300. Cap 2301 can be a snap-on cap, or can be placed gently over opening 2305.

In one embodiment of the invention, cap 2301 is configured to screw on to mold 2300. Mold 2300 can include an internal threading 2304 to facilitate removal of the food when cap 2301 is unscrewed from mold 2300.

FIG. 24 is a schematic representation of an embodiment of the invention in which mold 2400 comprises a deformable, relatively-soft, bag-like material that defines internal chambers 2401. The internal chambers are configured to receive food and can be sealed at ends 2402 and 2403 by any practicable means of sealing the mold while substantially retaining the shape of the filled mold. For example, the chambers could be sealed with a zipper-type configuration, or by adhesive on the bag. To remove the food, the mold could be cut, or the food could be pushed, by hand or otherwise, from the chamber.

The various molds described herein can comprise silicon, rubber, plastic, metal, or any material that allows for containing food. The materials can be chosen to withstand freezing and/or heating, and can be chosen to, or coated with material chosen to, facilitate loading and unloading the food from inside the mold.

The various food described herein can comprise herbs, spices, either alone or in combination with other food, and can be compactable, freezable, or take on any form that is amenable to cutting, within the context of embodiments of the present invention. Such herbs and spices include, but are not limited to, garlic, onion, basil and thyme.

The herbs (e.g., basil, garlic, etc.) can be frozen alone or with oil, water, or any other medium or media, or in combination with other herbs and media.

What is claimed is:

1. An apparatus, comprising:
a housing defining a chamber with a first chamber end and a second chamber end, the chamber configured to hold a substantially frozen herb cartridge of a predetermined configuration;
a pressure mechanism disposed within the chamber and configured to push the frozen herb cartridge toward the second chamber end; and
a cutting mechanism coupled to the housing and configured to cut the substantially frozen herb cartridge.

2. The apparatus of claim 1, wherein the cutting mechanism comprises
(i) an actuating handle coupled to, and biased away from, the housing; and
(ii) a cutting region configured to move relative to the housing.

3. The apparatus of claim 1, wherein the grater comprises
(i) an actuating handle pivotably coupled to the housing at pivot point; and
(ii) a grating region distal to the pivot point, the grating region configured to move relative to the second chamber end so as to grate the substantially frozen herb cartridge emerging from the second chamber end.

4. The apparatus of claims 2 or 3, further comprising a chamber closure configured to allow the substantially frozen herb cartridge to emerge from the second chamber end when the actuating handle is actuated.

5. The apparatus of claim 1, wherein the cutting mechanism is slidably coupled to the housing.

6. The apparatus of claim 5, wherein the apparatus further comprises an actuating handle, and wherein the cutting mechanism includes a cutting portion and a door portion configured to prevent an amount of the substantially frozen herb cartridge from exiting the second chamber end until the actuating handle is actuated.

7. The apparatus of claim 1, wherein the cutting mechanism is rotatably coupled to the housing.

8. The apparatus of claim 7, wherein the apparatus further comprises an actuating handle, and wherein the cutting mechanism includes a cutting portion and a door portion configured to prevent a portion of the substantially frozen herb cartridge from exiting the second chamber end.

9. The apparatus of claim 7, wherein the apparatus further comprises an actuating handle, and cutting mechanism is substantially planar, and defines a plane that intersects the axis of rotation.

10. An apparatus comprising:
a housing defining an internal chamber configured to receive a substantially frozen herb cartridge of predetermined shape and size, the internal chamber having an opening; and
a cutting element configured to move relative to the opening such that the cutting element removes portions of the substantially frozen herb cartridge when actuated.

11. The apparatus of claim 10, wherein the cutting element is coupled to a handle and is configured to be actuated by moving the handle.

12. The apparatus of claim 11, wherein the cutting element is outside the internal chamber.

13. The apparatus of claim 11, wherein the cutting element is inside the internal chamber.

14. The apparatus of claim 11, wherein the opening is a first opening, and wherein the housing includes a second opening in communication with the internal chamber and configured to allow a user to insert the cartridge into the internal chamber through the second opening.

16. The apparatus of claim 11, wherein the cutting element is biased away from the housing.

17. The apparatus of claim 11, wherein the food is biased toward the opening.

18. The apparatus of claim 11, wherein the cutting element is configured to rotate relative to the housing.

19. The apparatus of claim 18, wherein the housing defines and axis, and wherein the cutting element is configured to rotate substantially coaxially with the housing.

20. The apparatus of claim 18, wherein the housing defines a first axis, and wherein the cutting element rotates in a second axis substantially transverse to the first axis.

21. The apparatus of claim 11, wherein the cutting element is coupled to a handle, and wherein the handle includes a member configured to hold the handle in a position such that the opening is not blocked by the cutting element.

22. An apparatus comprising:
a housing defining an internal chamber and an opening, the internal chamber configured to receive a cartridge of substantially frozen herb;
a cutting element coupled to a hand actuator.

23. The apparatus of claim 22, wherein the housing and hand actuator are formed of a substantially unitary construction.

24. The apparatus of claim 22, wherein the housing, the handle, and the cutting element are formed of a substantially unitary construction.

25. The apparatus of claim 22, wherein the handle is coupled to the housing through a living hinge.
